(19) United States
(12) Patent Application Publication
(10) Pub. No.: US 2015/0065224 A1
(43) Pub. Date: Mar. 5, 2015

(54) SYSTEMS, METHODS AND DEVICES FOR PLAYING WAGERING GAMES WITH SYMBOL COLLECTION AND ACTIVATION FEATURES

(71) Applicant: WMS Gaming Inc., Waukegan, IL (US)

(72) Inventors: Dion K. Aoki, Chicago, IL (US); Brendon M. Fitzgerald, Henderson, NV (US)

(21) Appl. No.: 14/467,214

(22) Filed: Aug. 25, 2014

Related U.S. Application Data
(60) Provisional application No. 61/871,048, filed on Aug. 28, 2013.

(51) Int. Cl. G07F 17/34; G07F 17/32

(52) U.S. Cl. CPC G07F 17/34; G07F 17/3213
USPC 463/20

(57) ABSTRACT

Gaming machines, gaming systems, methods for conducting wagering games, and computer programs for operating gaming devices are disclosed. A gaming machine is presented which includes an input device for receiving wagers to play a wagering game, and a display device for displaying the wagering game. A processor executes instructions which cause the gaming machine to: display in a symbol array symbols indicative of a randomly determined wagering-game outcome, the symbols being selected from standard game symbols, collectable symbols, and activator symbols; for each collectable symbol in the wagering game outcome, display a transparent symbol superimposed in front of a corresponding array position of the collectable symbol; display new symbols indicative of a new randomly determined wagering-game outcome; responsive to an activator symbol in the new wagering-game outcome, display each transparent symbol turning the corresponding array position into a special symbol; and, evaluate the new game outcome for winning symbol combinations.

### CLAIM OF PRIORITY AND CROSS-REFERENCE TO RELATED APPLICATION

This application claims the benefit of priority to U.S. Provisional Patent Application No. 61/871,048, which was filed on Aug. 28, 2013, and is incorporated herein by reference in its entirety.

### COPYRIGHT

A portion of the disclosure of this patent document contains materials which are subject to copyright protection. The copyright owner has no objection to the facsimile reproduction by anyone of the patent disclosure as it appears in the U.S. Patent and Trademark Office patent files or records, but otherwise reserves all copyright rights whatsoever.

### TECHNICAL FIELD

The present disclosure relates generally to wagering games, as well as wagering game devices and gaming systems, computer program products, and method for conducting wagering games. More particularly, aspects of the present disclosure relate to systems, methods, and devices for playing wagering games with a symbol collection feature.

### BACKGROUND

Gaming terminals, such as slot machines, video poker machines and the like, have become a cornerstone of the gaming industry. Generally, the popularity of such machines with players is dependent on the likelihood (or perceived likelihood) of winning money at the machine and the intrinsic entertainment value of the machine relative to other available gaming options. Where the available gaming options include a number of competing machines and the expectation of winning at each machine is roughly the same (or believed to be the same), players are likely to be attracted to the most entertaining and exciting machines. Shrewd operators consequently strive to employ the most entertaining and exciting machines, features, and enhancements available because such machines attract frequent play and hence increase profitability to the operator. Thus, gaming manufacturers continuously endeavor to develop new games and improved gaming features and enhancements that will attract frequent play and player loyalty through enhanced entertainment value to the player.

One concept that has been successfully employed to enhance the entertainment value of a game is the concept of a “secondary” or “bonus” game that may be played in conjunction with a “primary” or “basic” game. The bonus game may comprise any type of game, either similar to or completely different from the basic game, which is entered upon the occurrence of a selected event or outcome during play of the basic game. Generally, bonus games provide a greater expectation of winning than the basic game and may also be accompanied with more attractive or unusual video and/or audio features. Because the bonus game concept offers tremendous advantages in player appeal and excitement relative to other game features, and because bonus games offer greater flexibility to game designers and operators, there is continuing development of new types of bonus games to satisfy player and operator demand.

Another concept that has been employed is the use of progressive jackpots. In the gaming industry, a “progressive jackpot” involves collecting coin-in data from participating gaming device(s), such as slot machines, contributing a percentage of that coin-in data to a progressive jackpot amount, and awarding that jackpot amount to a player upon the occurrence of a jackpot-winning event. A jackpot-winning event typically occurs when a “progressive winning position” is achieved at a participating gaming device. If the gaming device is a slot machine, a progressive winning position may, for example, correspond to alignment of progressive jackpot reel symbols along an active payline. The initial progressive jackpot is a predetermined minimum amount. That jackpot amount, however, progressively increases as players continue to play the gaming machine without winning the jackpot. Further, when several gaming machines are linked together such that several players at several gaming machines compete for the same jackpot, the jackpot progressively increases at a much faster rate.

Many gaming machines offer players the opportunity to win various awards and prizes in both primary games and bonus games. In reel-type gaming machines (more commonly referred to as “slot machines”), special symbols, such as wild symbols and win multiplier symbols, are used to increase the frequency and size of awards to players and thereby create player excitement, anticipation and enjoyment during play of the wagering game. One problem that arises is that special symbols in the wagering game are often unused or “lost” when they appear in a game outcome but do not form part of a winning combination. This can create disappointment for the player who visually perceives the special symbol but does not receive any of the attendant benefits. Another problem that exists is that special symbols are limited in number and, thus, appear with limited frequency. In addition, on any one play of the wagering game, special symbols are oftentimes limited in the size of award which can be generated.

### SUMMARY

Disclosed herein are wagering games with a primary game, a bonus game, and a symbol collection and activation feature. During play of either the primary game or the bonus game, or both, when a designated “collectable” symbol lands on the symbol array as part of a primary/bonus game outcome, a transparent “ghosted” symbol remains on the symbol array, superimposed in front of the array position on which the collectable symbol landed, for future plays. In the course of subsequent plays of the wagering game (e.g., during completion of a free-spin bonus game), a player can continue to collect these ghosted symbols at various positions on the symbol array. When a designated “activator” symbol appears in a future game outcome (e.g., on the rightmost reel of a multi-reel-game implementation or in another designated location or designated position), each collected ghost symbol turns their corresponding array position into a special symbol (e.g., a wild symbol) and then may concurrently disappear. In some implementations, the activator symbol may also act as or turn its corresponding array position into a special symbol. The game outcome is then evaluated (or reevaluated) for winning symbol combinations. At this juncture, the ghosted symbols may reappear and continue to operate in a similar manner for one or more subsequent plays of the primary/bonus game, for example, until a designated “deactivator” symbol appears or until the current bonus-game sequence ends.

According to one aspect of the present disclosure, a gaming system for conducting a wagering game is disclosed. The gaming system includes one or more input devices configured to receive a wager to play the wagering game, and one or more display devices operable to display aspects of the wagering game. The gaming system also includes one or more processors and one or more memory devices storing instructions that, when executed by at least one of the one or more processors, cause the one or more processors to: direct at least one of the one or more display devices to display a symbol array having a plurality of symbols located therein, the plurality of symbols being indicative of a randomly determined outcome of the wagering game, the symbols being selected from a plurality of available symbols including one or more standard game symbols, one or more collectable symbols, and one or more activator symbols; for each collectable symbol that is displayed in the symbol array as part of the wagering game outcome, display a respective transparent symbol superimposed in front of a corresponding array position of the collectable symbol; display in the symbol array a new plurality of symbols indicative of a new randomly determined outcome of the wagering game; in response to an activator symbol being displayed in the symbol array as part of the new wagering-game outcome, display each of the transparent symbols turning their corresponding array position into a respective special symbol; and, evaluate the new wagering-game outcome for one or more winning symbol combinations.

According to another aspect of the present disclosure, a gaming system for conducting a wagering game is presented. The gaming system includes one or more processors and one or more memory devices. The one or more memory devices store instructions that, when executed by at least one of the one or more processors, cause the gaming system to: in response to an indication of a wager received via an input device, determine a first outcome of the wagering game, the wagering game including a plurality of symbol-bearing reels, and the first outcome being randomly selected from a plurality of available wagering-game outcomes; direct a display device to display the reels populating a symbol array with symbols indicative of the first wagering-game outcome, the symbols being selected from a plurality of available symbols which includes one or more standard game symbols, one or more special game symbols, one or more collectable symbols, and one or more activator symbols; for each collectable symbol displayed in the symbol array as part of the first wagering game outcome, if any, direct the display device to display a respective transparent symbol superimposed in front of a corresponding array position of the collectable symbol for one or more subsequent plays of the wagering game; determine a second randomly selected outcome of the wagering game; direct the display device to display the symbol-bearing reels spinning while each of the transparent symbols remains immobile, superimposed in front of the symbol array; direct the display device to display the reels populating the symbol array with symbols indicative of the second wagering-game outcome; in response to an activator symbol being displayed within a predetermined activator-symbol area in the symbol array as part of the second wagering-game outcome, if any, direct the display device to display each of the transparent symbols turning their corresponding array position into a respective special symbol; and, evaluate the second wagering-game outcome for one or more winning symbol combinations.

Other aspects of the present disclosure are directed to a method for conducting a wagering game on a gaming system. The gaming system includes one or more input devices, one or more display devices, and one or more processors. The method includes: receiving, via at least one of the one or more input devices, an indication of a wager to play the wagering game; determining, via at least one of the one or more processors, an outcome of the wagering game, the outcome being randomly determined from a plurality of available wagering-game outcomes; displaying, via at least one of the one or more display devices, a symbol array populated with a plurality of symbols indicative of the randomly determined wagering-game outcome, the symbols being selected from a plurality of available symbols including one or more standard game symbols, one or more collectable symbols, and one or more activator symbols; displaying, via at least one of the one or more display devices for each collectable symbol displayed in the wagering game outcome, a respective transparent symbol superimposed in front of a corresponding array position of the collectable symbol; displaying, via at least one of the one or more display devices, the symbol array populated with a new plurality of symbols indicative of a new randomly determined outcome of the wagering game; displaying, via at least one of the one or more display devices in response to an activator symbol displayed in the new wagering-game outcome, each of the transparent symbols turning their corresponding array position into a respective special symbol; and, evaluating, via at least one of the one or more processors, the new wagering-game outcome for one or more winning symbol combinations.

In accordance with additional aspects of this disclosure, one or more physical non-transitory machine-readable storage media are featured that include instructions which, when executed by one or more processors, cause the one or more processors to direct a gaming terminal and/or a gaming system to perform any of the methods and/or operations disclosed herein. For example, the operations may comprise: receiving from at least one input device an indication of a wager to play the wagering game; determining an outcome of the wagering game, the outcome being randomly determined from a plurality of available wagering-game outcomes; directing at least one display device to display a symbol array populated with a plurality of symbols indicative of the randomly determined wagering-game outcome, the symbols being selected from a plurality of available symbols which includes one or more standard game symbols, one or more collectable symbols, and one or more activator symbols; for each collectable symbol displayed in the wagering game outcome, directing at least one display device to display a respective transparent symbol superimposed in front of a corresponding array position of the collectable symbol; directing at least one display device to display the symbol array populated with a new plurality of symbols indicative of a new randomly determined wagering-game outcome; in response to an activator symbol displayed in the new wagering game outcome, directing at least one display device to display each of the transparent symbols turning the corresponding array position into a respective special symbol; and, evaluating the new game outcome for one or more winning symbol combinations.

The above summary is not intended to represent each embodiment or every aspect of the present disclosure. Rather, this summary merely provides an exemplification of some of the novel features presented herein. The above features and advantages, and other features and advantages of the present invention, will be readily apparent from the following detailed description of exemplary embodiments and modes for carrying out the present invention when taken in connection with the accompanying drawings and the appended claims.

### BRIEF DESCRIPTION OF THE DRAWINGS

FIG. 1 is a perspective-view illustration of an example of a free-standing gaming terminal according to aspects of the present disclosure.

FIG. 2 is a schematic diagram of an example of a gaming machine in a representative gaming system according to aspects of the present disclosure.

FIG. 3 is a screen shot of an example of a basic-game screen of a wagering game displayed on a gaming terminal, gaming device, and/or gaming system according to aspects of the present disclosure.

FIG. 4 is a screen shot of a display device displaying an exemplary wagering game with a symbol collection and activation feature in accordance with aspects of the present disclosure.

FIG. 5 is another screen shot of the exemplary wagering game displayed via the display device of FIG. 4, wherein a number of designated “collectable” symbols in the wagering game outcome are collected and concomitantly shown turning into transparent symbols.

FIG. 6 is another screen shot of the exemplary wagering game displayed via the display device of FIG. 4, wherein the symbol-bearing reels are shown spinning while the collected transparent symbols remain immobile, superimposed in front of the symbol array.

FIG. 7 is yet another screen shot of the exemplary wagering game displayed via the display device of FIG. 4, wherein a designated “activator” symbol is shown appearing within a designated activator-symbol area in a new randomly determined game outcome.

FIG. 8 is still another screen shot of the exemplary wagering game displayed via the display device of FIG. 4, wherein the collected transparent symbols are shown turning their corresponding array positions into special symbols in response to the displayed activator symbol.

FIG. 9 is even yet another screen shot of the exemplary wagering game displayed via the display device of FIG. 4, wherein the game outcome is shown being evaluated for winning symbol combinations and the player is awarded an award for a corresponding winning symbol combination.

FIG. 10 is another screen shot of the exemplary wagering game displayed via the display device of FIG. 4, wherein the collected transparent symbols are shown reappearing in front of the symbol array and the activator symbol is shown turning into a transparent symbol.

FIG. 11 is yet another screen shot of the exemplary wagering game displayed via the display device of FIG. 4, wherein a new designated activator symbol is shown appearing within a designated activator symbol area in the randomly determined game outcome.

FIG. 12 is still another screen shot of the exemplary wagering game displayed via the display device of FIG. 4, wherein the collected transparent symbols are shown turning their corresponding array positions into special symbols in response to the new activator symbol.

FIG. 13 is even yet another screen shot of the exemplary wagering game displayed via the display device of FIG. 4, wherein the new game outcome is shown being evaluated for winning symbol combinations and the player is awarded another award for a corresponding winning symbol combination.

FIG. 14 is a flowchart for an exemplary method or algorithm that can correspond to instructions that can be stored on one or more non-transitory computer-readable media and can be executed by one or more controllers in accord with aspects of the disclosed concepts.

While aspects of this disclosure are susceptible to various modifications and alternative forms, specific embodiments are shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

This invention is susceptible of embodiment in many different forms. There are shown in the drawings and will herein be described in detail representative embodiments of the invention with the understanding that the present disclosure is to be considered as an exemplification of the principles of the invention and is not intended to limit the broad aspects of the invention to the embodiments illustrated. To that extent, elements and limitations that are disclosed, for example, in the Abstract, Summary, and Detailed Description sections, but not explicitly set forth in the claims, should not be incorporated into the claims, singly or collectively, by implication, inference or otherwise. For purposes of the present detailed description, unless specifically disclaimed: the singular includes the plural and vice versa; the words “and” and “or” shall be both conjunctive and disjunctive; the word “all” means “any and all”; the word “any” means “any and all”; and the words “including” and “comprising” mean “including without limitation.” Moreover, words of approximation, such as “about,” “almost,” “substantially,” “approximately,” and the like, can be used herein in the sense of “at, near, or nearly at,” or “within 3-5% of,” or “within acceptable manufacturing tolerances,” or any logical combination thereof, for example.

For purposes of the present detailed description, the terms “wagering games,” “gambling,” “slot game,” “casino game,” and the like include games in which a player places at risk a sum of money or other representation of value, whether or not redeemable for cash, on an event with an uncertain outcome, including without limitation those having some element of skill. In some embodiments, the wagering game may involve wagers of real money, as found with typical land-based or on-line casino games. In other embodiments, the wagering game may additionally, or alternatively, involve wagers of non-cash values, such as virtual currency, and therefore may be considered a social or casual game, such as would be typically available on a social networking web site, other web sites, across computer networks, or applications on mobile devices (e.g., phones, tablets, etc.). When provided in a social or casual game format, the wagering game may closely resemble a traditional casino game, or it may take another form that more closely resembles other types of social/casual games. It should also be noted that the recitation of a gaming terminal, machine, device or system can be used interchangeably in the specification and claims, unless explicitly delimited.

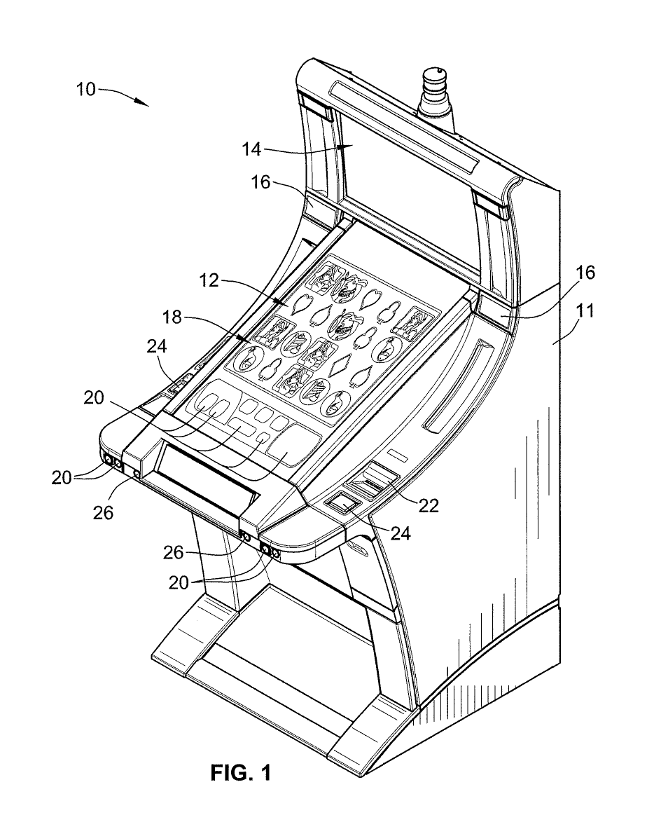

Referring to the drawings, wherein like reference numerals refer to like features throughout the several views, there is shown in FIG. 1 a representative gaming terminal 10 similar to those used in conventional gaming establishments, such as casinos, hotels and cruise ships, and non-conventional gaming establishments, such as airports and restaurants. With regard to the present disclosure, the gaming terminal 10 may be any type of gaming terminal and may have varying structures and methods of operation. For example, in some aspects, the gaming terminal 10 is an electromechanical gaming terminal configured to play slots with mechanical reels, whereas in other aspects, the gaming terminal is an electronic gaming terminal configured to play a video casino game, such as slots, keno, poker, blackjack, roulette, craps, etc. The gaming terminal 10 may take any suitable form, such as floor-standing models (as shown), handheld mobile devices, bartop models, workstation-type console models, etc. Further, the gaming terminal 10 may be primarily dedicated for use in conducting wagering games, or may include non-dedicated devices, such as mobile smartphones, personal digital assistants, personal computers, etc. Exemplary types of gaming terminals are disclosed in U.S. Pat. No. 6,517,433 B2, U.S. Patent Application Pub. Nos. US 2010/0069160 A1 and US 2010/0234099 A1, and International Application No. PCT/US2007/000792, all of which are incorporated herein by reference in their respective entireties and for all purposes.

The gaming terminal 10 illustrated in FIG. 1 comprises a cabinet 11 that may house various input devices, output devices, and input/output devices. By way of non-limiting example, the gaming terminal 10 includes a primary display area 12, a secondary display area 14, and one or more audio speakers 16. The primary display area 12 or the secondary display area 14 may be a mechanical-reel display, a video display, or a combination thereof in which a transmissive video display may be disposed in front of the mechanical-reel display to portray a video image superimposed upon the mechanical-reel display. A video display is, in various embodiments, a cathode ray tube (CRT), a high-resolution liquid crystal display (LCD), a plasma display, a light emitting diode (LED), a DLP projection display, an electroluminescent (EL) panel, or any other type of display suitable for use in the gaming terminal 10. The display areas may variously display information associated with wagering games, non-wagering games, community games, progressive games, advertisements, services, premium entertainment, text messaging, emails, alerts, announcements, broadcast information, subscription information, etc., appropriate to the particular mode(s) of operation of the gaming terminal 10. The gaming terminal 10 includes a touch screen(s) 18 mounted over the primary and/or secondary areas 12, 14, buttons 20 on a button panel, bill validator 22, information reader/writer(s) 24, and player-accessible port(s) 26 (e.g., audio output jack for headphones, video headset jack, USB port, wireless transmitter/receiver, etc.). It should be understood that numerous other peripheral devices and other elements exist and are readily utilizable in any number of combinations to create various forms of a gaming terminal in accord with the present disclosure.

Video images in the primary display area 14 and/or the secondary display area 16 can be rendered in two-dimensional (e.g., using Flash Macromedia™) or three-dimensional graphics (e.g., using Renderware™). In various aspects, the video images are played back (e.g., from a recording stored on the gaming terminal 10), streamed (e.g., from a gaming network), or received as a TV signal (e.g., either broadcast or via cable). Such images can take different forms, such as animated images, computer-generated images, or “real-life” images, either prerecorded (e.g., in the case of marketing/promotional material) or as live footage. The format of the video images can include any format including, but not limited to, an analog format, a standard digital format, or a high-definition (HD) digital format.

Input devices, such as the touch screen 18, buttons 20, a mouse, a joystick, a gesture-sensing device, a voice-recognition device, and a virtual input device, accept player input(s) and transform the player input(s) to electronic data signals indicative of the player input(s), which correspond to an enabled feature for such input(s) at a time of activation (e.g., pressing a “Max Bet” button or soft key to indicate a player's desire to place a maximum wager to play the wagering game). The input(s), once transformed into electronic data signals, are output to a CPU for processing. The electronic data signals can be selected from a group consisting essentially of an electrical current, an electrical voltage, an electrical charge, an optical signal, an optical element, a magnetic signal, and a magnetic element.

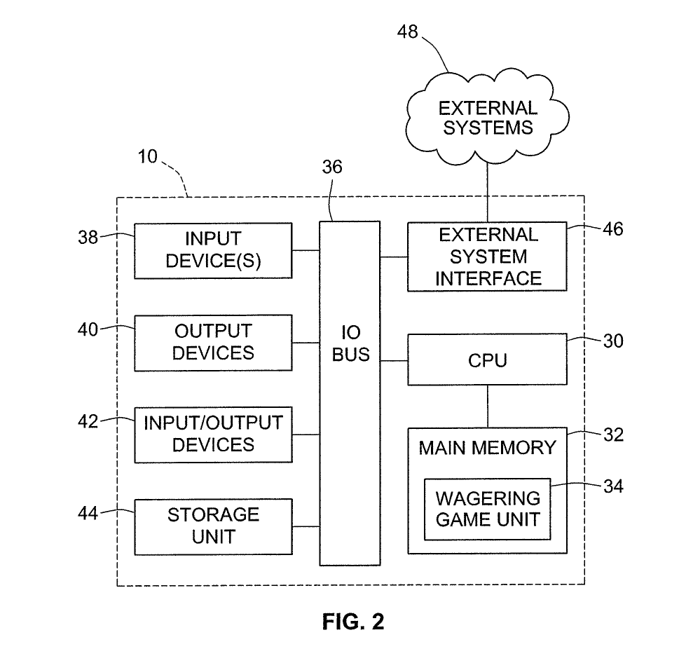

Turning now to FIG. 2, there is shown a block diagram of the gaming-terminal architecture. The gaming terminal 10 includes a central processing unit (CPU) 30 connected to a main memory 32. The CPU 30 may include any suitable processor(s), such as those made by INTEL® and AMD®. By way of example, the CPU 30 includes a plurality of microprocessors including a master processor, a slave processor, and a secondary or parallel processor. CPU 30, as used herein, comprises any combination of hardware, software, or firmware disposed in or outside of the gaming terminal 10 that is configured to communicate with or control the transfer of data between the gaming terminal 10 and a bus, another computer, processor, device, service, or network. The CPU 30 comprises one or more controllers or processors and such one or more controllers or processors need not be disposed proximal to one another and may be located in different devices or in different locations. The CPU 30 is operable to execute all of the various gaming methods and other processes disclosed herein. The main memory 32 includes a wagering game unit 34. In one embodiment, the wagering game unit 34 may present wagering games, such as video poker, video black jack, video slots, video lottery, etc., in whole or part.

The CPU 30 is also connected to an input/output (I/O) bus 36, which can include any suitable bus technologies, such as an AGTL+ frontside bus and a PCI backside bus. The I/O bus 36 is connected to various input devices 38, output devices 40, and input/output devices 42 such as those discussed above in connection with FIG. 1. The I/O bus 36 is also connected to storage unit 44 and external system interface 46, which is connected to external system(s) 48 (e.g., wagering game networks).

The external system 48 includes, in various aspects, a gaming network, other gaming terminals, a gaming server, a remote controller, communications hardware, or a variety of other interfaced systems or components, in any combination. In yet other aspects, the external system 48 may comprise a player's portable electronic device (e.g., cellular phone, electronic wallet, etc.) and the external system interface 46 is configured to facilitate wireless communication and data transfer between the portable electronic device and the CPU 30, such as by a near-field communication path operating via magnetic-field induction or a frequency-hopping spread spectrum RF signals (e.g., Bluetooth, etc.).

The gaming terminal 10 optionally communicates with the external system 48 such that the terminal operates as a thin, thick, or intermediate client. In general, a wagering game includes a random number generator (RNG) for generating a random number, game logic for determining the outcome based on the randomly generated number, and game assets (e.g., art, sound, etc.) for presenting the determined outcome to a player in an audio-visual manner. The RNG, game logic, and game assets are contained within the gaming terminal 10 (“thick client” gaming terminal), the external system 48 (“thin client” gaming terminal), or are distributed therebetween in any suitable manner (“intermediate client” gaming terminal).

The gaming terminal 10 may include additional peripheral devices or more than one of each component shown in FIG. 2. Any component of the gaming terminal architecture may include hardware, firmware, or tangible machine-readable storage media including instructions for performing the operations described herein. Machine-readable storage media includes any mechanism that stores information and provides the information in a form readable by a machine (e.g., gaming terminal, computer, etc.). For example, machine-readable storage media includes read only memory (ROM), random access memory (RAM), magnetic disk storage media, optical storage media, flash memory, etc.

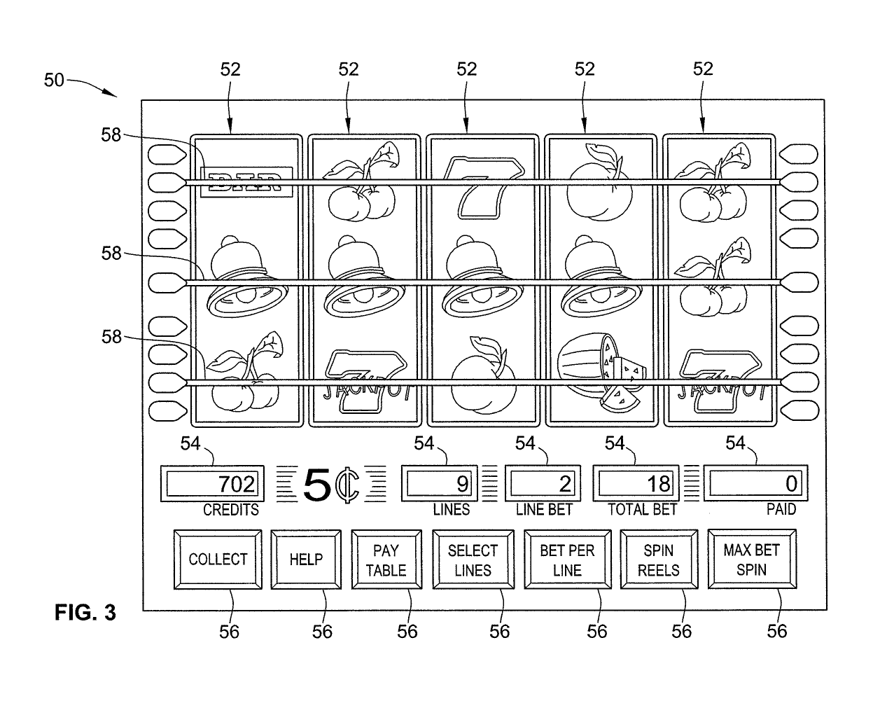

Referring now to FIG. 3, there is illustrated an image of a basic-game screen 50 adapted to be displayed on the primary display area 12 or the secondary display area 14. The basic-game screen 50 portrays a plurality of simulated symbol-bearing reels 52. Alternatively or additionally, the basic-game screen 50 portrays a plurality of mechanical reels or other video or mechanical presentation consistent with the game format and theme. The basic-game screen 50 also advantageously displays one or more game-session credit meters 54 and various touch screen buttons 56 adapted to be actuated by a player. A player can operate or interact with the wagering game using these touch screen buttons or other input devices such as the buttons 20 shown in FIG. 1. The CPU operate(s) to execute a wagering game program causing the primary display area 12 or the secondary display area 14 to display the wagering game.

In response to receiving a wager, the reels 52 are rotated and stopped to place symbols on the reels in visual association with paylines such as paylines 58. The wagering game evaluates the displayed array of symbols on the stopped reels and provides immediate awards and bonus features in accordance with a pay table. The pay table may, for example, include “line pays” or “scatter pays.” Line pays occur when a predetermined type and number of symbols appear along an activated payline, typically in a particular order such as left to right, right to left, top to bottom, bottom to top, etc. Scatter pays occur when a predetermined type and number of symbols appear anywhere in the displayed array without regard to position or paylines. Similarly, the wagering game may trigger bonus features based on one or more bonus triggering symbols appearing along an activated payline (i.e., “line trigger”) or anywhere in the displayed array (i.e., “scatter trigger”). The wagering game may also provide mystery awards and features independent of the symbols appearing in the displayed array.

In accord with various methods of conducting a wagering game on a gaming system in accord with the present concepts, the wagering game includes a game sequence in which a player makes a wager and a wagering game outcome is provided or displayed in response to the wager being received or detected. The wagering game outcome is then revealed to the player in due course following initiation of the wagering game. The method comprises the acts of conducting the wagering game using a gaming apparatus, such as the gaming terminal 10 depicted in FIG. 1, following receipt of an input from the player to initiate the wagering game. The gaming terminal 10 then communicates the wagering game outcome to the player via one or more output devices (e.g., primary display 12 or secondary display 14) through the display of information such as, but not limited to, text, graphics, static images, moving images, etc., or any combination thereof. In accord with the method of conducting the wagering game, the CPU transforms a physical player input, such as a player's pressing of a “Spin Reels” touch key, into an electronic data signal indicative of an instruction relating to the wagering game (e.g., an electronic data signal bearing data on a wager amount).

In the aforementioned method, for each data signal, the CPU (e.g., CPU 30) is configured to process the electronic data signal, to interpret the data signal (e.g., data signals corresponding to a wager input), and to cause further actions associated with the interpretation of the signal in accord with computer instructions relating to such further actions executed by the controller. As one example, the CPU causes the recording of a digital representation of the wager in one or more storage media (e.g., storage unit 44), the CPU, in accord with associated computer instructions, causing the changing of a state of the storage media from a first state to a second state. This change in state is, for example, effected by changing a magnetization pattern on a magnetically coated surface of a magnetic storage media or changing a magnetic state of a ferromagnetic surface of a magneto-optical disc storage media, a change in state of transistors or capacitors in a volatile or a non-volatile semiconductor memory (e.g., DRAM), etc. The noted second state of the data storage media comprises storage in the storage media of data representing the electronic data signal from the CPU (e.g., the wager in the present example). As another example, the CPU further, in accord with the execution of the instructions relating to the wagering game, causes the primary display 12, other display device, or other output device (e.g., speakers, lights, communication device, etc.) to change from a first state to at least a second state, wherein the second state of the primary display comprises a visual representation of the physical player input (e.g., an acknowledgement to a player), information relating to the physical player input (e.g., an indication of the wager amount), a game sequence, an outcome of the game sequence, or any combination thereof, wherein the game sequence in accord with the present concepts comprises acts described herein. The aforementioned executing of computer instructions relating to the wagering game is further conducted in accord with a random outcome (e.g., determined by an RNG) that is used by the CPU to determine the outcome of the game sequence, using a game logic for determining the outcome based on the randomly generated number. In at least some aspects, the CPU is configured to determine an outcome of the game sequence at least partially in response to the random parameter.

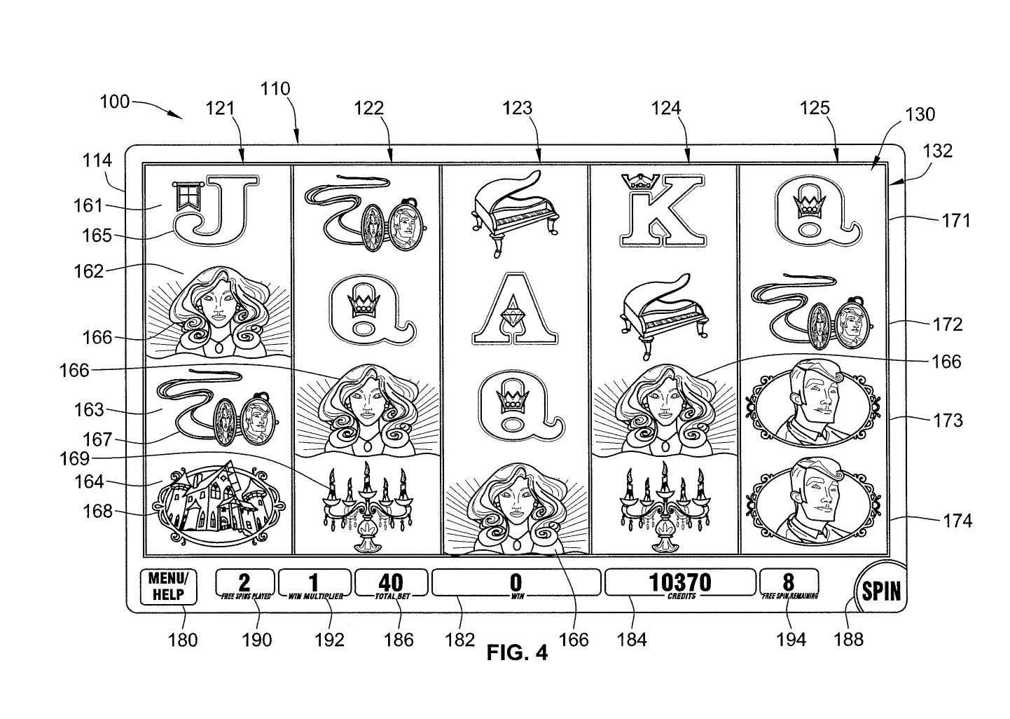

FIG. 4 is a screen shot of a game screen from an exemplary wagering game in accordance with aspects of the present disclosure. A primary display 114 of a gaming device or terminal 110, which may be part of an exemplary gaming system 100, is shown in FIG. 4. Although differing in appearance, the gaming terminal 110 can be similar in function, operation and connectivity to the gaming terminal 10 discussed above with respect to FIGS. 1 and 2 and, thus, can include any of the options, features and alternatives described above. For example, the gaming terminal 110 (also referred to herein as “wagering game machine” or “gaming machine”) may be an electromechanical gaming terminal configured, for example, to play mechanical slots, or it may be an electronic gaming terminal configured, for example, to play a video casino game, such as keno, poker, slots, blackjack, roulette, etc. In this regard, the gaming terminal 110 can take on various alternative configurations, including, without limitation, upright freestanding gaming machines, slant-top freestanding gaming machines, handheld and portable gaming devices, countertop gaming machines, personal computers and laptop computers, smartphones, tablet computers, or other known gaming devices, individually or in any combination thereof. Moreover, the display device 114 is operable to display wagering games, such as those described above with respect to FIGS. 1-3 and/or those described below with respect to FIGS. 4-14, for example. The display device 114 may be any form of display, such as those described with reference to the free-standing gaming terminal 10 of FIG. 1. For instance, the primary display 114 may comprise a plasma, LED, OLED, AMOLED, LCD, CRT, or projection display device, or any other now-known or later-developed display device.

The display device 114 displays or otherwise visually depicts a wagering game 130, which in this example is a reel-type “slot” wagering game. The slot game 130 includes a plurality of symbol-bearing reels, designated as 121-525 in FIG. 4, each having a plurality of distinct reel positions (collectively represented in FIG. 4 by four reel positions 161-164 on the first reel 121) occupied by a number of symbols (collectively represented in FIG. 4 by four reel symbols 165-168 on the first reel 121). The reels 121-125 displayed on the primary display 114 may be electro-mechanical reels, computer-generated simulations of mechanical slot reels, other replicated forms of reels, or any variation or combination thereof. The symbols borne by these reels may include any variety of graphical symbols, emblems, elements, or representations, including symbols that are associated with one or more themes of the gaming terminal 110 (e.g., a Ghost Mystery theme). The reel positions may also include blank symbols or empty spaces.

The symbols on the reels 121-125, when part of a wagering-game outcome, are arranged in an array 132, which in this embodiment is a 4×5 matrix—four rows by five columns—of distinct array positions (20 total array positions in FIG. 4, which are collectively represented by four array positions 171-174 occupied by symbols of the fifth reel 125). The reels 121-125 are varied (e.g., spun and stopped) to reveal combinations of symbols, which represent randomly selected outcomes of the wagering game 130, that are evaluated for winning symbol combinations. Winning combinations of symbols landing, for example, on activated paylines (e.g., those paylines for which a wager has been received) which extend through the array positions cause awards to be paid in accordance with one or more pay tables associated with the wagering game 130. In some embodiments, winning combinations of symbols include three or more like symbols aligned adjacent one another on an active pay line (e.g., left-to-right configuration, right-to-left configuration, or both). In some embodiments, symbol combinations are evaluated in accord with various other schemes such as, but not limited to, scatter pays.

Within the scope of this disclosure, the wagering game 130 can include greater or fewer than five symbol-bearing reels (simulated, mechanical, or otherwise), each of which may include greater or fewer reel positions and reel symbols than those described with respect to FIG. 4. In alternate embodiments, the randomly selected outcomes may comprise greater or fewer than 20 symbols, and may take on a variety of different forms having greater or fewer rows and/or columns. The array 130 may even comprise other non-rectangular forms or arrangements of symbols. Moreover, the randomly selected outcomes of the wagering game 130 may be varied from the representation provided in FIG. 4. Although numerous aspects of the wagering game 130 are all shown displayed on a single display device, namely the primary display 114, these aspects are not so limited and can be displayed in any combination on any number of display devices unless otherwise expressly prohibited.

The primary display 114 further includes certain display features for providing information and options to a player. For example, the display 114 features may include a MENU/HELP button 180, a WIN meter 182, a CREDITS meter 184, and a TOTAL BET meter 186. The MENU/HELP button 180 can be pressed and activated (e.g., through an overlying touch screen) by a player desiring to access other control menus, preferences, help screens, informational menus, etc. For example, the player can change a theme of the wagering game 130 via the MENU button 180, or change the type of the wagering game (e.g., to video poker, keno, etc.). The WIN meter 182 displays to the player the amount of the total win (if any) from the most recent play of the wagering game 130. The CREDITS meter 184 displays to the player the total amount of credits (if any) remaining and available to the player for play of the wagering game 130. The TOTAL BET meter 186 displays to a player the current size of his/her wager (in credits). Once a number of paylines are selected and a wager is placed, a SPIN button 188 can be pressed or otherwise activated by a player to effectuate rotation of the reels 121-125. In an optional configuration, selection of a SPIN button will automatically effectuate rotation of the reels 121-125 without requiring prior selection of a wager and/or a number of paylines (e.g., a default wager and a default number of payline(s) are automatically chosen upon selection of the SPIN button 188).

Fewer, additional, or alternative display features may be included for presenting information and/or options to a player. In one specific instance, a row of player-selectable LINES buttons can be provided to give players the option of quickly selecting and activating a predetermined number of paylines (e.g., 1, 5, 9, 20 or 40 lines). Another option would be to display a row of player-selectable bet PER LINE buttons, which gives a player the option of quickly selecting a predetermined bet per active payline (e.g., 1, 2, 3, 5 and 10 credits per activated payline). The primary display 114 can also include, for example, an optional CHANGE DENOM button that can be utilized to change the denomination of each wagered credit (e.g., from 1¢ per credit to 25¢ per credit) which the player is inputting into the system 500. For a free-spin bonus game implementation, the display 114 may also include a FREE SPINS PLAYED meter 190, which displays to the player the number of bonus game spins that have been completed (if any) in a current bonus round, a WIN MULTIPLIER meter 192, which shows the size of a bonus-game-award multiplier available (if any) in a current bonus round, and a FREE SPINS REMAINING meter 194, which displays to the player the number of bonus game spins that have yet to be completed to finish a current bonus round. Other features may include, in some non-limiting examples, one or more bet change buttons that permit a player to incrementally increase and/or decrease the size of his/her wager, a MAX BET SPIN button for wagering a maximum number of credits and contemporaneously varying the reels of the wagering game, as well as any of the other buttons and meters presented herein or other features now known or hereinafter developed.

The wagering game 130 is shown in FIG. 4 after play of a free-spin bonus game segment has been initiated, which may be subsequent to when a base game segment is initiated, for example, by a player providing a wager (e.g., responsive to an input via at least one input device), and thereafter pressing a spin button or pulling a spin lever. The monetary wager, which is typically a selected number of credits, is deducted from the available credits, e.g., the 10,370 credits displayed via the CREDITS meter 184 in FIG. 4. The monetary wager that is in play (e.g., 40 credits in FIG. 4) can be displayed via the TOTAL BET meter 186. The reels 121-125 may then be varied (e.g., spun and stopped); the reels 121-125 continue to spin until they are stopped to reveal in the displayed array 132 reel symbols which represent a randomly selected outcome of the wagering game 130. The wagering-game outcome is, according to some aspects, randomly determined from a plurality of potential wagering-game outcomes. As indicated above, each outcome is evaluated for winning symbol combinations or other winning positions to determine if the displayed outcome has one or more awards associated therewith.

A local controller (e.g., CPU 30 of FIG. 2), a host system (e.g., external system 48 of FIG. 2), a central controller, or any combination thereof, in alternative embodiments, operates to execute a wagering game program causing the display area 114 to display selected portions of the wagering game 130. An outcome of the wagering game 130, be it for a base portion, a bonus portion, a progressive portion, a community portion, or otherwise, can be randomly selected from a predetermined set of potential (base, bonus, progressive, community, etc.) wagering-game outcomes, for example, using a local or remote random number generator (RNG). The wagering-game outcome is then revealed, displayed, or otherwise communicated to the player, for example, on a corresponding display device 114. The game screen 114 of FIG. 4, for example, displays the wagering-game outcome by portraying the reels 121-125 spinning and sequentially stopping to reveal reel symbols arranged in a symbol array. A winning combination occurs, for example, when the displayed array of symbols comprise one or more of the winning symbol combinations listed in a predetermined pay table. In response to a winning outcome, a wagering-game prize (e.g., a monetary award of credits) associated with that winning outcome is conferred upon the player.

As indicated above, FIG. 4 may be representative of the commencement of a free-spin bonus game which was triggered during play of a base wagering game (e.g., via a bonus-game-triggering symbol combination along an active payline in a base-game outcome). In the illustrated embodiment, the player accumulated or was otherwise awarded ten (10) free spins in the bonus game, which is indicated by the FREE SPINS PLAYED meter 190 showing that two bonus-game spins have been completed and the FREE SPINS REMAINING meter 194 showing that eight bonus-game spins have yet to be completed. In alternative embodiments, the player may be awarded greater or fewer free spins, may make selections that determine how many free bonus spins he/she receives, or may be awarded a number of free bonus spins that are not predetermined (e.g., may be allowed to spin until they lose, may be allowed to spin until they receive a bonus-game-ending symbol, symbol combination, or event, etc.) The reels 121-125, which may be bonus-game reels that are identical to or different from a set of base-game symbol-bearing reels, are spun and stopped to reveal symbols indicative of a randomly selected outcome of the bonus game.

The symbols borne by the reels 121-125 may include a variety of graphical symbols, including one or more standard game symbols, one or more special game symbols, one or more collectable symbols, and/or one or more activator symbols. Some of the standard symbols that are shown in FIG. 4 are designated with reference numerals, such as a jack symbol 165 and a locket symbol 167, as well as those not designated with reference numerals, such as a queen symbol, a king symbol, an ace symbol, and a piano symbol, etc. All of the standard symbols shown in the array 132 in FIG. 4 may be symbols which form winning combinations for which prizes are awarded. In other words, the standard symbols appear in a pay table of the wagering game 130 and are each typically associated with one or more predetermined prize amounts.

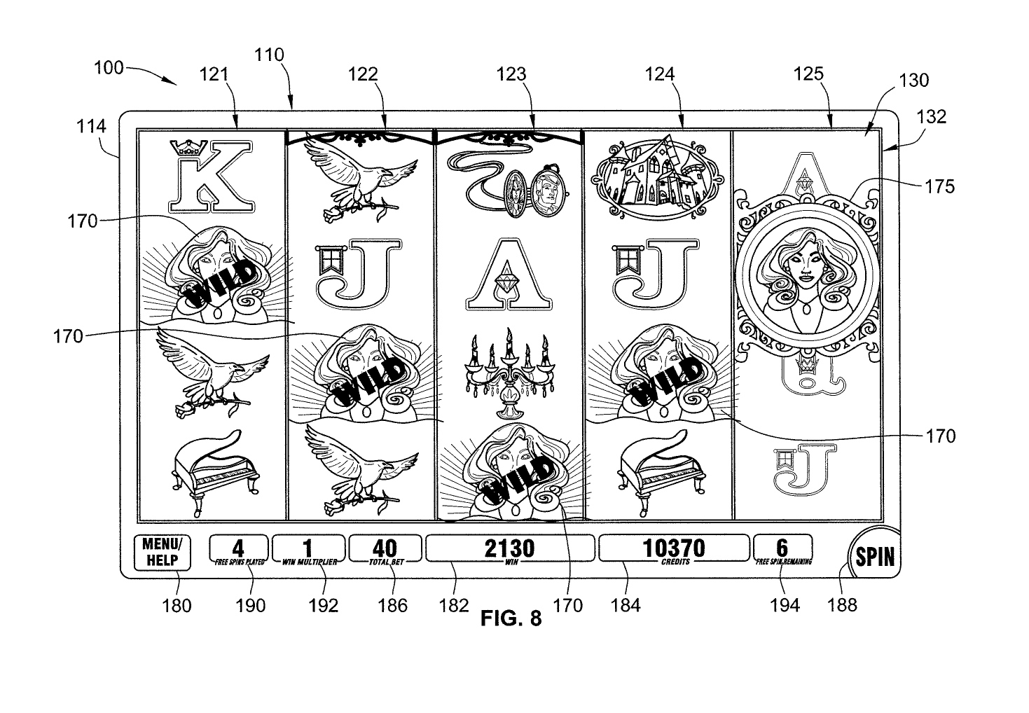

By way of contrast, one or more of the symbols borne by the reels 121-125 are “special symbols,” which are given additional functionality, purpose, weight, and/or evaluation as compared to “standard symbols.” One example of a special symbol shown in FIG. 4 is the bonus symbol 168 that, when included in a wagering game outcome (singly or in combination with other bonus symbols), operates to trigger a (Mystery Mansion) bonus game. Alternatively, a bonus game may be mystery triggered or may be triggered by any suitable trigger condition during game play. As another example of a special symbol, a conditional-multiplier symbol 169, when included in a wagering game outcome (singly or in combination with other conditional-multiplier symbols), operates to increase a bonus-game-award multiplier available in the current bonus round of the wagering game 130, which is displayed to the player in the WIN MULTIPLIER meter 192. In another non-limiting example, a wild symbol 170 (FIG. 8) is a special symbol that, when included in a wagering game outcome, operates as a “wild” symbol to replace any other symbol so as to improve a player's chances of obtaining a winning combination of symbols on one or more active paylines. In some embodiments, a wild symbol may have restrictions to its substitution abilities—e.g., a wild symbol may substitute for any standard symbol to create award-winning symbol combinations, but may not substitute for other special symbols. In other embodiments, the functionality of a special symbol may take on different functions, such as the symbol acting as a scatter symbol (instead of or in addition to being a line-paying symbol), a win multiplier symbol, a win-multiplying wild symbol, an expanding wild symbol, a re-spin symbol, a symbol upgrade, etc.

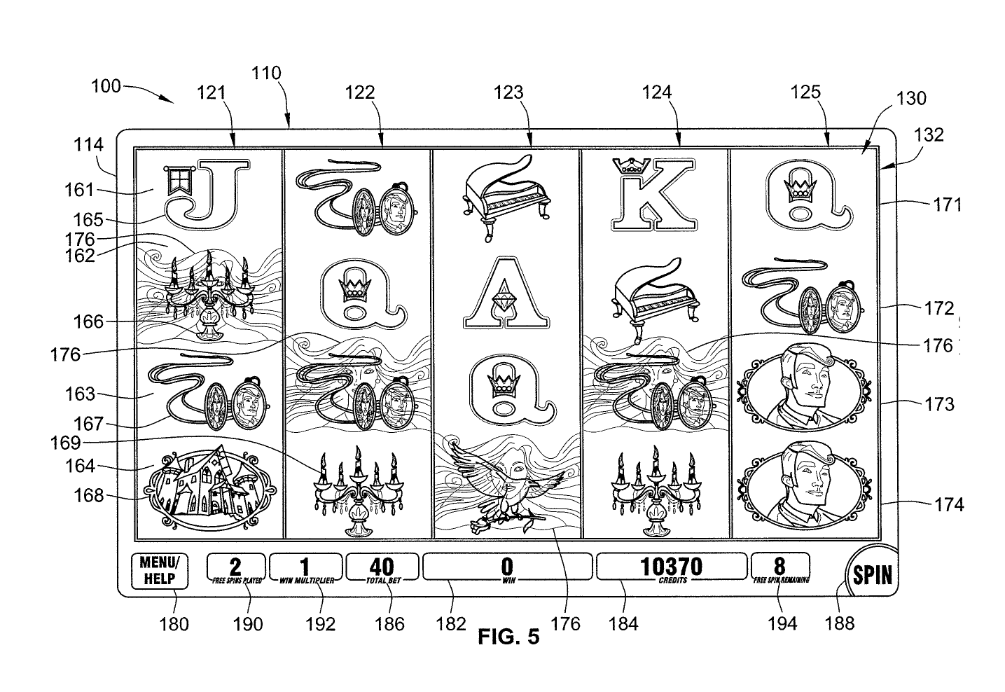

Amongst the symbols borne by the reels 121-125 are one or more designated “collectable” symbols, some of which are identified in the drawings with reference numeral 166, and one or more designated “activator” symbols, some of which are identified in the drawings with reference numeral 175. In FIG. 4, for example, four collectable symbols 166 landed on the reels 121-125 during a play of the free-spin bonus game. In this embodiment, because the collectable symbols 166 can be accumulated and subsequently redeemed, collection of these symbols 166 occurs. In one non-limiting example of symbol collection, for each collectable symbol 166 displayed in the symbol array 132 as part of a wagering game outcome, a respective transparent symbol 176 is superimposed in front of the corresponding array position of the symbols 166, as seen in FIG. 5. This may include dynamically displaying the collectable symbols 166 on the reels 121-124 sequentially changing into transparent “ghosted” symbols 176, each of which is situated in front of and overlays at least the array position that was occupied by the corresponding collectable symbol (and potentially one or more adjacent array positions). In addition to the designated collectable symbols 166 being collected, these symbols 166 may first be used during evaluation of the game outcome for winning symbols and symbol combinations on active paylines. For some implementations, the collectable symbols 166 may act as special symbols (e.g., wild symbols) for this initial evaluation. In some embodiments, after the collectable symbols 166 transform into transparent “ghosted” symbols 176, standard symbols and, optionally, special symbols can be systematically and/or randomly added to the now-vacant reel positions on the underlying reels 121-125, as seen in FIG. 5, and an evaluation of the bonus game outcome for winning symbols and symbol combinations is undertaken.

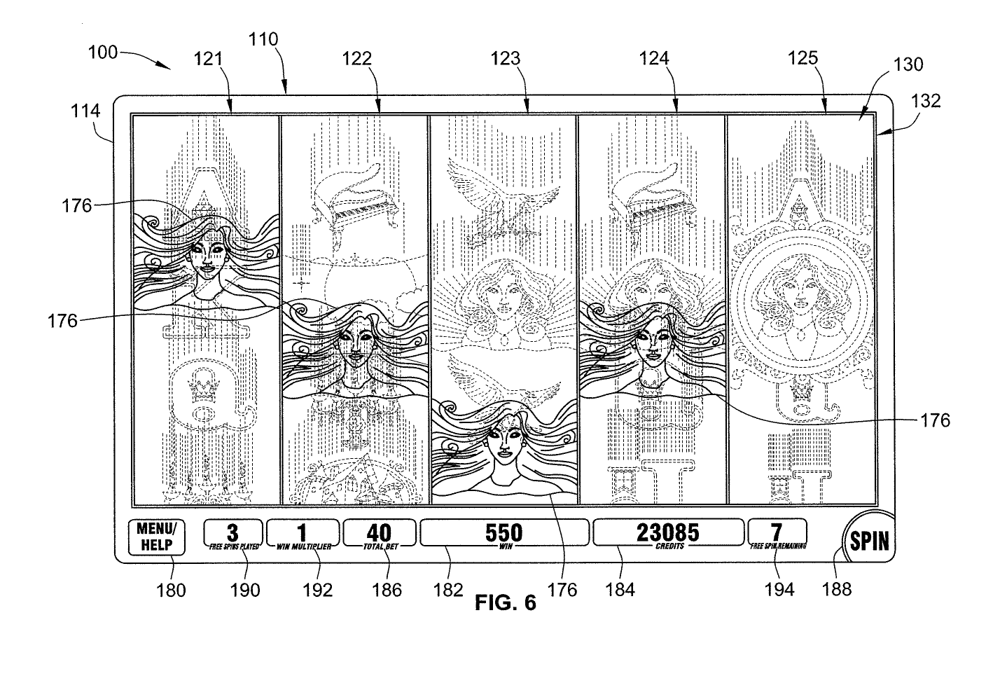

Subsequent to collecting the collectable symbols 166, but prior to populating the symbol array 132 with new symbols as part of a new randomly determined wagering-game outcome, the symbol-bearing reels 121-125 are shown in FIG. 6 spinning while each of the transparent symbols 176 remains immobile, superimposed in front of the symbol array 132 overlaying at least one of the array positions. This is not to say that the transparent symbols 176 are completely static; rather, the symbols 176 do not move location relative to the symbol array 132 but may otherwise incorporate visual effects and movements within or around the symbol itself. This stationary, superimposed display of the transparent symbols 176 can persist in a semi-continuous or continuous and uninterrupted manner for multiple plays of the wagering game 130 (e.g., until an activator symbol 175 appears). Doing so creates heightened player excitement, anticipation and enjoyment during play of the wagering game 130. It is desirable that, for at least some preferred embodiments, the player can continue to collect the collectable symbols 166 throughout continued play and until completion of the bonus game (e.g., during all of the free bonus spins).

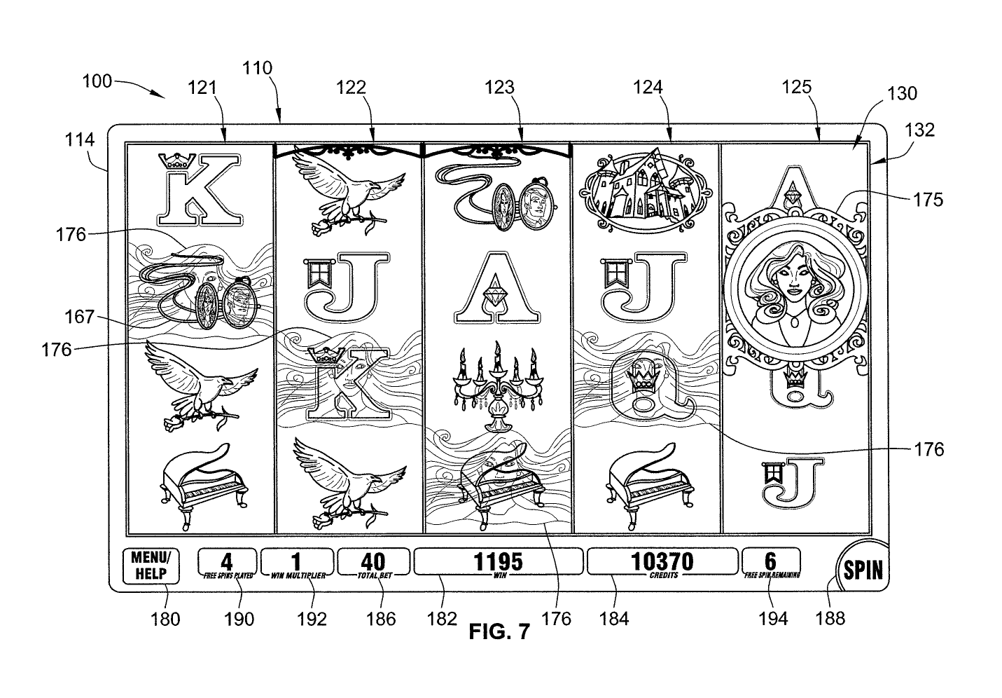

In accordance with the illustrated example, the collectable symbols 166 are collected, then stored, and later redeemed to the same locations from which they were collected. Optionally, or alternatively, the collectable symbols 166 may be redeemed at other predetermined or randomly determined locations. With reference to FIG. 7, for example, the display 114 is shown following the conclusion of two more of the free spins in the free-spin bonus game, as indicated by the incremented number of spins displayed in the FREE SPINS PLAYED meter 190 (i.e., four (4) spins played) and the corresponding decremented number of spins displayed in the FREE SPINS REMAINING meter 194 (i.e., six (6) spins remaining) The reels 121-125 are shown in FIG. 7 populating the symbol array 132 with new symbols that are indicative of a new randomly determined wagering-game outcome. As part of this new outcome, an activator symbol 175 is displayed in the symbol array 132 on the right-most “fifth” reel 125. For some implementations, the activator symbol 175 is superimposed over one or more standard symbols and, optionally, the standard symbols are reduced in size to highlight the presence of the activator symbol 175.

The appearance of an activator symbol 175 in a game outcome operates to redeem all (or select ones) of the collectable symbols 166 that have been collected during one or more or all of the heretofore completed spins of the bonus game. As seen in FIG. 8, for example, the transparent “ghosted” symbols 176 of FIGS. 5-7, which act as visual representations of the collectable symbols 166 that were collected in FIGS. 4 and 5, are shown turning the reel symbols aligned with their corresponding array positions into special symbols in response to the activator symbol 175 displayed in the symbol array 132. For instance, the locket symbol 167 on the first reel 121 of FIG. 7, which is in the first column, second row of the array 132, underneath but at least partially visible through a transparent “ghosted” symbols 176 that is superimposed over that array position, has been turned into a wild symbol 170 in FIG. 8. In the same vein, the second, third and fourth reels 122-124 of FIG. 7 each includes a standard symbol that is positioned underneath but is at least partially visible through a transparent “ghosted” symbol 176 that is superimposed over the array 132; these three standard symbols have all been turned into wild symbols 170 in FIG. 8. In some implementations, the activator symbol 175 may also act as or turn its corresponding array position into a special symbol (e.g., a wild symbol). In other embodiments, other rule sets may be utilized to control which reel symbols the redeemed collectable symbols 166 may or may not replace. By way of example, the transparent “ghosted” symbols 176, when redeeming the collectable symbols 166, can replace randomly selected standard symbols on the reels 121-125. Redemption of the collectable symbols 166 may be depicted in a variety of ways, and may include entertaining graphics and sounds as the transparent “ghosted” symbols 176 convert standard symbols into special symbols.

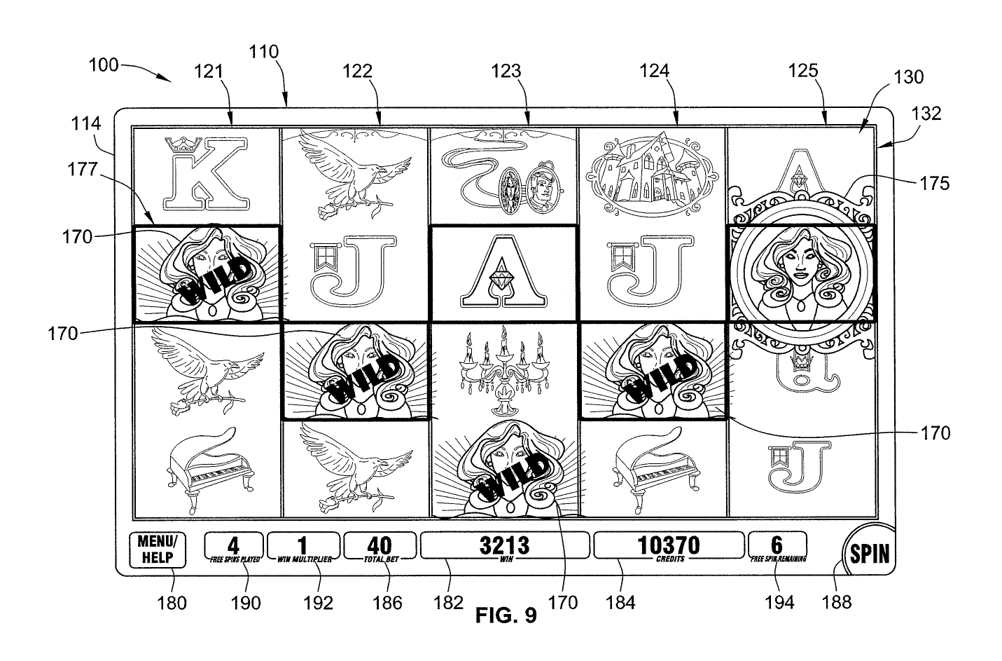

Turning next to FIG. 9, conclusion of the initial redemption of collectable symbols 166 is shown and evaluation of the new game outcome for one or more winning symbols and/or winning symbol combinations on active paylines is commenced. For some implementations, the new game outcome is evaluated once before the symbol redemption, and then reevaluated a second time after the symbol redemption. In the illustrated example, the player has achieved numerous winning-symbol combinations, including a five ace-symbol winning combination, which is highlighted and emphasized for the player with a group of interconnected winning symbol boxes 177 in FIG. 9. This winning outcome results in a very large award of 3213 credits, which is displayed to the player in the WIN meter 182. The occurrence and size of this winning symbol combination was made possible through the collection and redemption of the collectable symbols 166. With the larger number of wild symbols 170 provided by the foregoing symbol collection and activation feature, the chances of a player achieving at least one winning combination, as well as achieving numerous winning combinations and achieving higher paying winning combinations, is greatly increased. In this way, the collection and redemption of the collectable symbols 166 increases player excitement as larger amounts of special symbols are allowed to be simultaneously employed and evaluated.

For some implementations, triggering redemption of the collectable symbols 166 may require that the activator symbol 175 appear within a predetermined activator-symbol area (e.g., anywhere within the fifth column of the symbol array's 132 five-column matrix) or on a predetermined activator-symbol location (e.g., on a designated position of the symbol array 132). Alternatively, redemption may require that a minimum number of activator symbols 175 appear within the symbol array 132, e.g., either aligned side-by-side along an active payline or “scattered” anywhere within the array 132. Another optional limitation may require that all of the special symbols generated during redemption (i.e., those provided by the transparent symbols 176) be the same type of special symbol (e.g., a wild symbol). While some embodiments may limit availability of the symbol collection and activation feature to a secondary bonus game (e.g., appearance of the collectable symbols 166, the transparent symbols 176, and the activator symbols 175 only occur during a free-spin bonus game), other embodiments may offer the same (or similar or different) symbol collection and activation feature during the base game.

In the illustrated example, the transparent symbols 176 disappear prior to and/or substantially concurrent with the evaluation of the new game outcome for winning symbol combinations. Optionally, the transparent symbols 176 can be shown disappearing after the aforementioned evaluation. What's more, the manner in which the transparent symbols 176 disappear can in-and-of itself take on various formats, including the symbols 176 disappearing in an abrupt flash or a slow fadeout or a transition to somewhere off-screen and outside of the player's view, all of which may coincide with a visually appealing and entertaining graphical display. For some preferred embodiments, the transparent symbols 176 are continuously displayed superimposed in front of the symbol array 132, e.g., for one or more subsequent plays of the wagering game 130, until the activator symbol 175 is displayed in the symbol array 132 as part of a new wagering game outcome. Alternatively, the transparent symbols 176 can be continuously displayed superimposed in front of the symbol array 132, e.g., for one or more subsequent plays of the wagering game 130, until a deactivator symbol is displayed as part of a wagering game outcome.

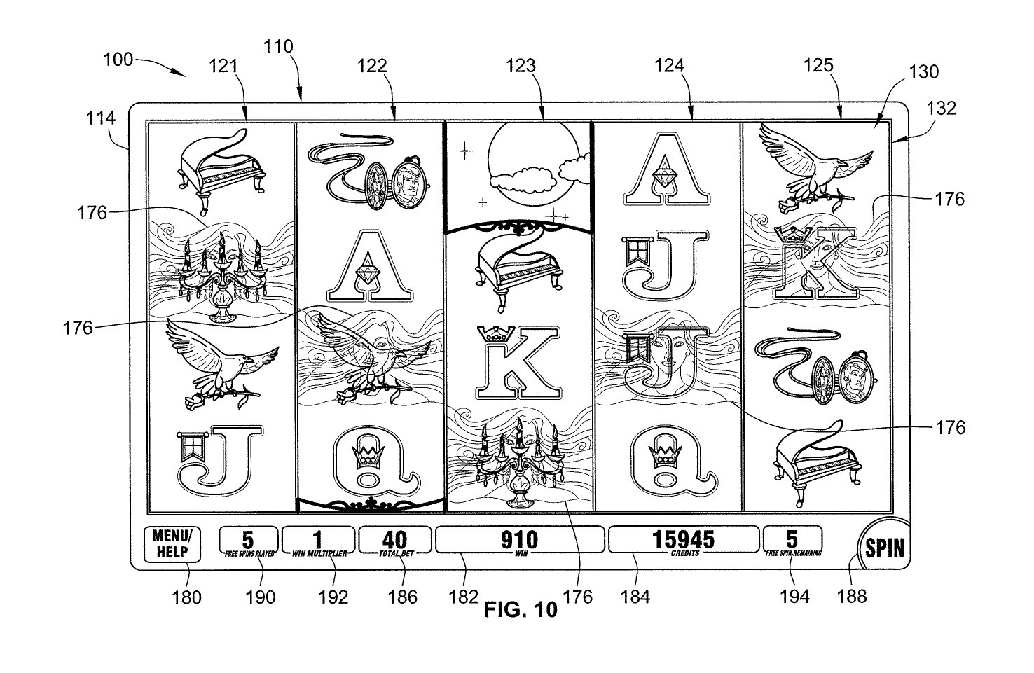

FIG. 10 provides another screen shot of the exemplary wagering game 130 displayed via the display device 114 of FIG. 4, now showing the game 130 after completion of the initial collection, then redemption and subsequent evaluation of the symbols. In this screen shot, the collected transparent symbols 176 from FIG. 5-7 are shown reappearing in front of the symbol array 132 overlaying their respective array positions. In effect, this allows the player to not only collect numerous collectable symbols throughout the sequential plays of the wagering game 130, but also to redeem the collected symbols more than once during play of the wagering game 130. Another optional feature portrayed in FIG. 10 is that the activator symbol 175 can also act as a collectible symbol—i.e., the activator symbol 175 from FIGS. 7-9 is shown in FIG. 10 turning into a transparent symbol 176 that is superimposed in front the symbol array 132 for one or more subsequent plays of the wagering game 130. In such an implementation, the activator symbol 175 can also include at least some (if not all) of the features, options and alternatives described above with respect to the collectable symbols 166.

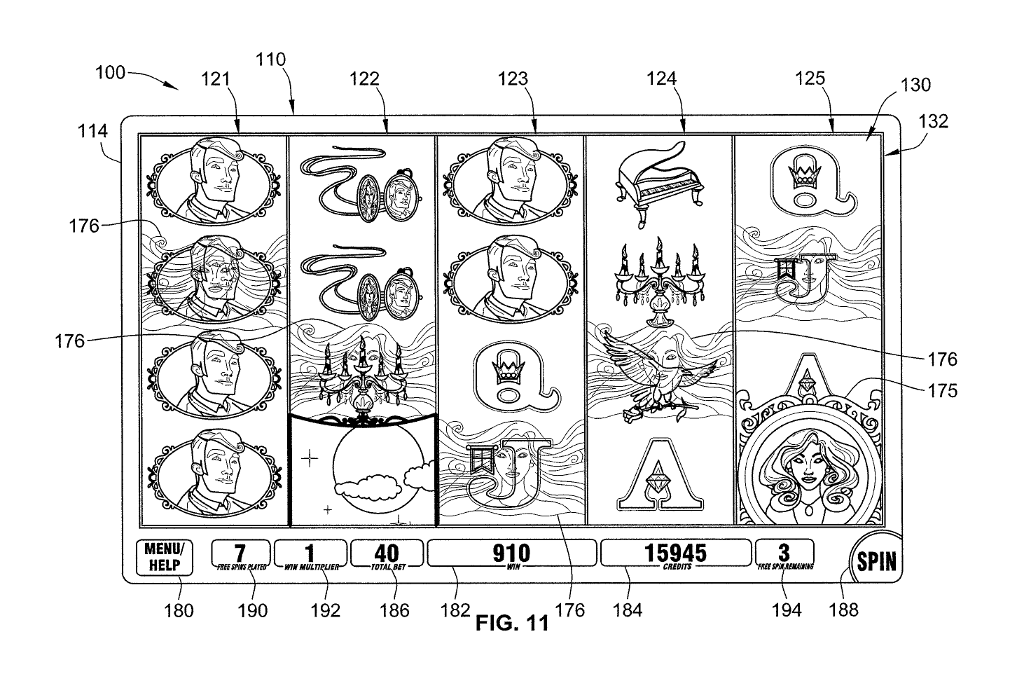

FIG. 11 illustrates another screen shot of the wagering game 130 following the conclusion of two more of the free spins in the free-spin bonus game, as indicated by the incremented number of spins displayed in the FREE SPINS PLAYED meter 190 (i.e., seven (7) total spins played) and the corresponding decremented number of spins displayed in the FREE SPINS REMAINING meter 194 (i.e., three (3) total spins remaining) The reels 121-125 are shown in FIG. 11 populating the symbol array 132 with new symbols that are indicative of another new randomly determined wagering-game outcome. As part of this new outcome, another activator symbol 175 is displayed in the symbol array 132, located on the right-most reel 125, two reel/array positions below the transparent “ghosted” symbols 176 that was generated as a result of the activator symbol 175 from FIG. 7.

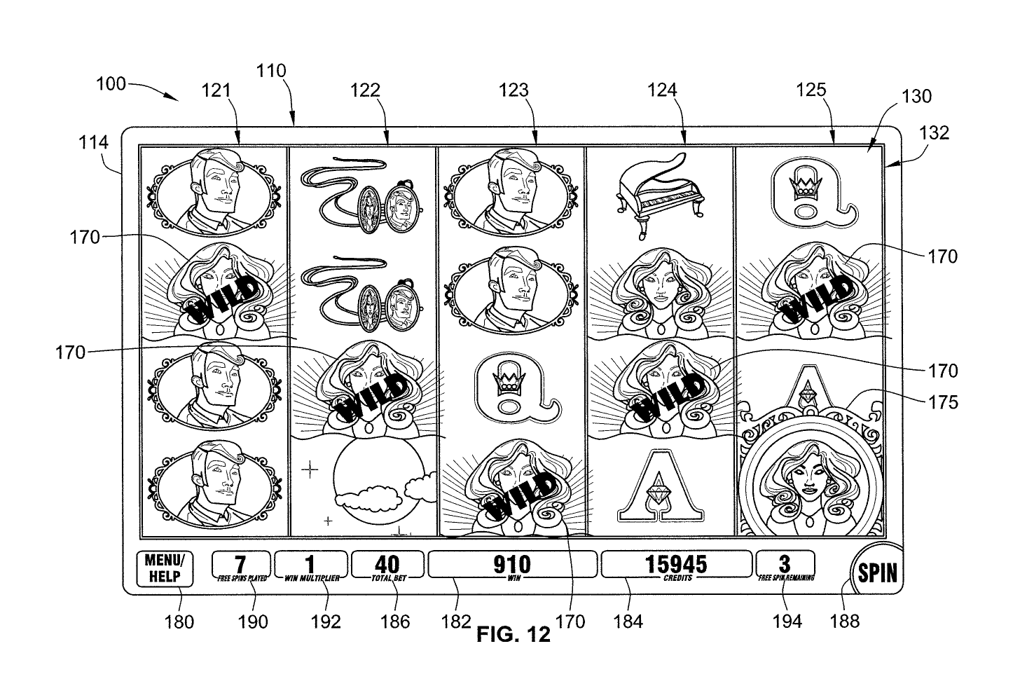

The collectable symbols 166 are once again redeemed to the same locations from which they were collected, as shown in FIG. 12. The transparent “ghosted” symbols 176 of FIGS. 10-11, which act as visual representations of the symbols that were collected (or re-collected) in FIG. 9, are shown turning the reel symbols aligned with their corresponding array positions into wild symbols 170 in response to the newest activator symbol 175 which appeared in the symbol array 132 in FIG. 12. In this implementation, the activator symbol 175 also acts as a special “wild” symbol for purposes of evaluating the wagering game outcome for winning symbols/symbol combinations.

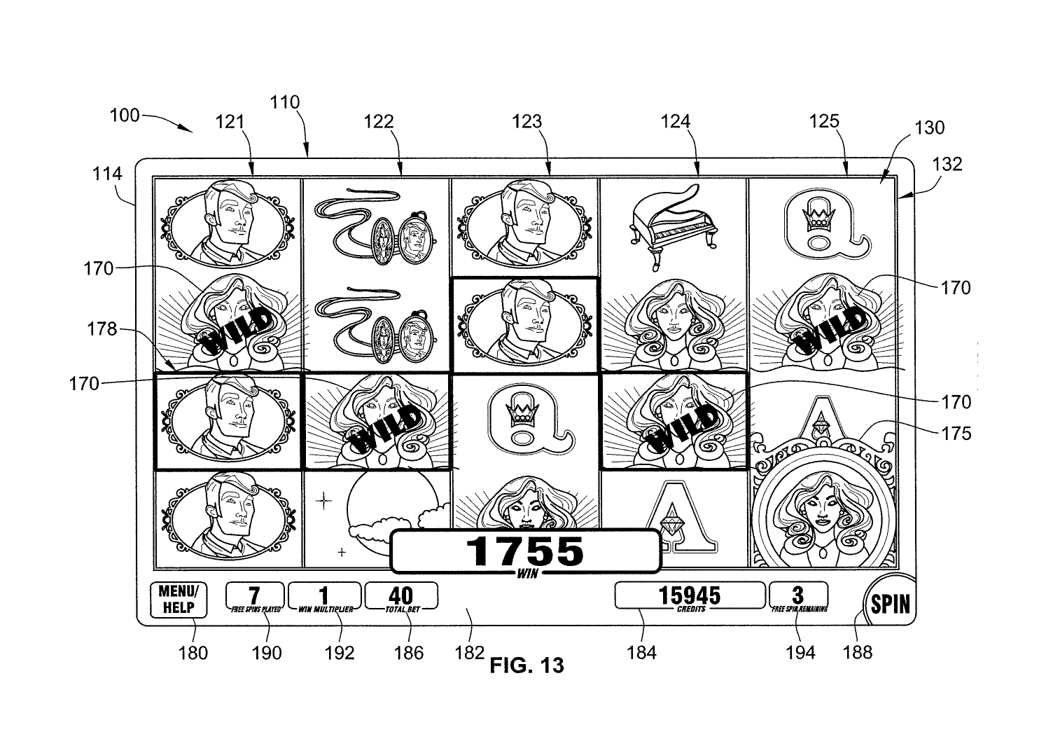

FIG. 13 depicts the conclusion of the latest redemption of collectable symbols, and the commencement of the corresponding evaluation of the new game outcome for one or more winning symbols and/or winning symbol combinations on active paylines. Optionally, the game outcome is evaluated once before the symbol redemption, and then a second time after the symbol redemption. In the example illustrated in FIG. 13, the player has achieved at least one winning-symbol combination, namely a four-beau-symbol winning combination that is highlighted and emphasized for the player with a group of interconnected winning symbol boxes 178. This winning outcome results in a large award of 1755 credits, which is displayed to the player in the WIN meter 182.

There are numerous optional and alternative embodiments that are possible for the core functionality of the disclosed concepts. By way of example, and not limitation, the special symbols that are provided during redemption of the collectable symbols could take on various alternative forms, including bonus-game-triggering symbols, progressive-jackpot-triggering symbols, special evaluation symbols, win-multiplying symbols, symbol upgrade symbols, etc., in addition to or instead of wild symbols. Moreover, more than one type of special symbol could be provided at a given time. As another option, rather than disappearing, the special symbols that are provided as a result of the redemption of the collectable symbols could remain for the remainder of the free spins in the free-spin bonus and be evaluated for every spin. For some embodiments, various solutions could be implemented if a collectable symbol lands in an already designated position (e.g., the resultant transparent “ghosted” symbol will generate a win-multiplying wild for that array position upon the appearance of an activator symbol).

In alternate embodiments, collection of the collectible symbols need not occur only during free spins, as shown in the FIGURES, but could also occur during regular plays of the wagering game. Collection of collectible symbols may require other criteria be met, such as only occurring if the collectible symbol(s) appear on active/designated paylines, only occurring if certain betting criteria have been satisfied, etc. Similarly, redemption may occur in a multitude of different ways, including after a predetermined number of activator symbols have been collected, upon player selection, or randomly executed. Moreover, redemption may be limited to partial redemption of some, but not all of the collected symbols on one play of the wagering game, as opposed to redemption of all of the collected symbols in a single play. In addition, the redemption of collected symbols may occur by distributing the transparent symbols into the matrix according to a defined formula, pattern, and/or algorithm. Moreover, the player may be permitted to select where the redeemed symbols are placed in the matrix. Many alternative collection and redemption mechanisms may be employed.

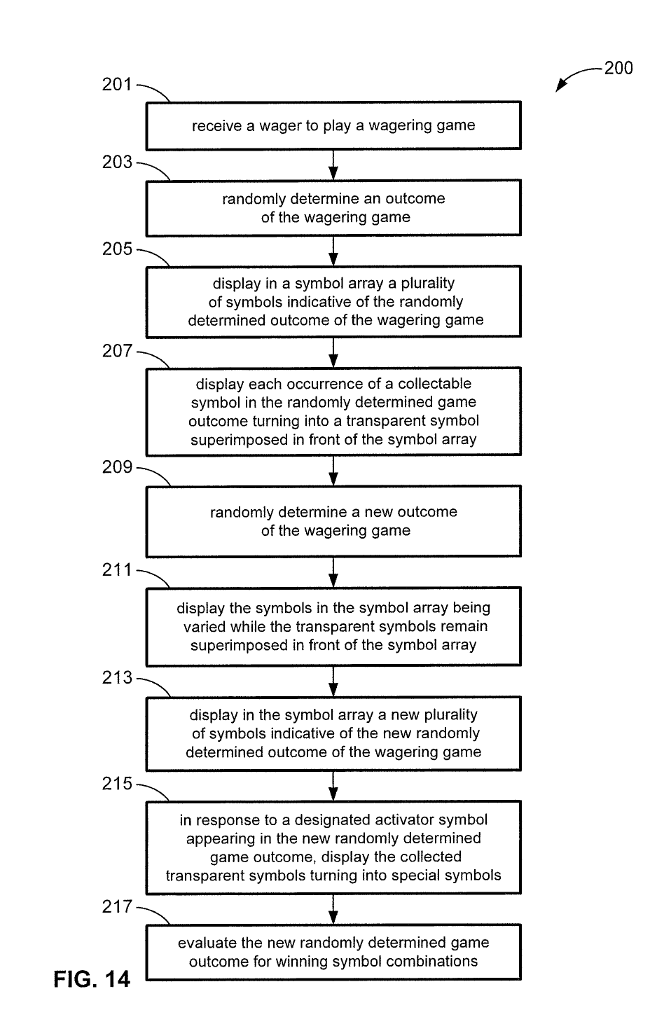

With reference now to the flow chart of FIG. 14, an improved method for conducting a wagering game on a gaming terminal and/or a gaming system, such as those shown in FIGS. 1-13, for example, is generally described at 200 in accordance with aspects of the present disclosure. FIG. 14 can be representative of an algorithm that corresponds to at least some instructions that can be stored, for example, in main memory 32 of FIG. 2, and executed, for example, by the CPU 30 and/or external system(s) 48 of FIG. 2 to perform any or all of the above or below described functions associated with the disclosed concepts. The method 200 will be described with reference to the various aspects and features shown in FIGS. 4 and 13 of the drawings; such reference is being provided purely by way of explanation and clarification.

The method 200 begins at step 201 with receiving (e.g., via at least one of one or more input devices, such as touch screen 18, bill validator 22, information reader/writer 24, etc.) an indication of a wager to play the wagering game. For some embodiments, the wagering game includes a number of symbol-bearing reels, each of which has a plurality of distinct reel positions populated by various symbols. Examples of such wagering games, including an assortment of features, options and alternatives that may be incorporated into the method 200, have been described in extensive detail hereinabove with reference to FIGS. 1-4. FIG. 4, for example, presents a slot-type wagering game 130 which includes a plurality of symbol-bearing reels 121-125 each having a plurality of distinct reel positions populated by symbols.

At step 203, an outcome of the wagering game is determined, e.g., via at least one of the one or more processors. For instance, an outcome of a base-game portion (or, alternatively, a bonus-game portion, a progressive-game portion, a community-game portion, etc.) of the wagering game is randomly determined from a plurality of available wagering-game outcomes. This may include, as indicated above, an RNG generating a random number, game logic for determining the outcome based on the randomly generated number, and the CPU 30, the external system 48, or both, in alternative embodiments, operating to execute a wagering game program, and game assets (e.g., art, sound, etc.) for presenting the determined outcome to a player in a visual manner.

In step 205, the method includes displaying, via at least one of one or more display devices (e.g., the primary display 114 of gaming terminal 110 of FIG. 4), a symbol array populated with a plurality of symbols indicative of the randomly determined wagering-game outcome. These symbols are selected from a plurality of available symbols, which includes one or more standard game symbols, one or more special game symbols, one or more collectable symbols, and one or more activator symbols. As noted above, the base-game outcome of the wagering game 130 and/or the bonus-game outcome of the wagering game 130 can be visually represented by a plurality of symbols arranged on a display device, such as the symbols 165-169 on the slot reels 135-139 that are arranged in the symbol array 132 of FIG. 4.

At step 207, at least one display device displays, for each collectable symbol that is displayed in the wagering game outcome, a respective transparent symbol superimposed in front of a corresponding array position of the collectable symbol. As noted above, the reels 121-125 include various types of symbols, including one or more designated “collectable” symbols 166. For each collectable symbol 166 that is displayed in the symbol array 132 as part of a wagering game outcome, a respective transparent “ghosted” symbol 176 is subsequently shown superimposed in front of the corresponding array position of the symbols 166, as seen in FIG. 5.

The method 200 then includes, at step 209, randomly determining a new outcome of the wagering game. This determination sequence can be conducted in any manner described above or in any manner otherwise known in the art. Contemporaneous with this determination, or at some point thereafter, the method 200 further comprises, in step 211, displaying the symbol array being varied while the aforementioned transparent symbols remain superimposed in front of the symbol array. The symbol-bearing reels 121-125 of FIG. 6 are shown spinning while each of the transparent symbols 176 remains immobile, superimposed in front of the symbol array 132 overlaying at least one of the array positions.

In accord with step 213 of FIG. 14, the method 200 then includes displaying, via at least one display device, the symbol array being populated with new symbols that are indicative of the new randomly determined outcome of the wagering game. In one non-limiting example, the reels 121-125 are shown in FIG. 7 populating the symbol array 132 with new symbols that represent a new randomly determined wagering-game outcome. As part of this new outcome, an activator symbol 175 is displayed in the symbol array 132 on the right-most “fifth” reel 125. In response to an activator symbol being displayed in the new wagering-game outcome, each of the transparent symbols is shown turning its corresponding array position into a respective special symbol, as required by step 512. For instance, the appearance of the activator symbol 175 in a game outcome operates to redeem the collectable symbols 166 that have been collected during the bonus game. As seen in FIG. 8, for example, the transparent “ghosted” symbols 176 of FIGS. 5-7, which act as visual representations of the collectable symbols 166 that were collected in FIGS. 4 and 5, are shown turning the reel symbols aligned with their corresponding array positions into special symbols in response to the activator symbol 175 displayed in the symbol array 132. At step 217, the method 200 requires evaluating the new wagering-game outcome for one or more winning symbols or symbol combinations (e.g., via at least one processor).

In some embodiments, the method includes at least those steps enumerated above. It is also within the scope and spirit of the present invention to omit steps, include additional steps, and/or modify the order presented above. It should be further noted that the foregoing method can be representative of a single sequence for playing a wagering game. However, it is expected that the method will be practiced in a systematic and repetitive manner.

Aspects of this disclosure can be implemented, in some embodiments, through a computer-executable program of instructions, such as program modules, generally referred to as software applications or application programs executed by a computer. The software can include, in non-limiting examples, routines, programs, objects, components, and data structures that perform particular tasks or implement particular abstract data types. The software can form an interface to allow a computer to react according to a source of input. The software can also cooperate with other code segments to initiate a variety of tasks in response to data received in conjunction with the source of the received data. The software can be stored on any of a variety of memory media, such as CD-ROM, magnetic disk, bubble memory, and semiconductor memory (e.g., various types of RAM or ROM).

Moreover, aspects of the present disclosure can be practiced with a variety of computer-system and computer-network configurations, including hand-held devices, multiprocessor systems, microprocessor-based or programmable-consumer electronics, minicomputers, mainframe computers, and the like. In addition, aspects of the present disclosure can be practiced in distributed-computing environments where tasks are performed by remote-processing devices that are linked through a communications network. In a distributed-computing environment, program modules can be located in both local and remote computer-storage media including memory storage devices. Aspects of the present disclosure can therefore, be implemented in connection with various hardware, software or a combination thereof, in a computer system or other processing system.

Any of the methods described herein can include machine readable instructions for execution by: (a) a processor, (b) a controller, and/or (c) any other suitable processing device. Any algorithm, software, or method disclosed herein can be embodied in software stored on a tangible medium such as, for example, a flash memory, a CD-ROM, a floppy disk, a hard drive, a digital versatile disk (DVD), or other memory devices, but persons of ordinary skill in the art will readily appreciate that the entire algorithm and/or parts thereof could alternatively be executed by a device other than a controller and/or embodied in firmware or dedicated hardware in a well known manner (e.g., it can be implemented by an application specific integrated circuit (ASIC), a programmable logic device (PLD), a field programmable logic device (FPLD), discrete logic, etc.). Also, some or all of the machine readable instructions represented in any flowchart depicted herein can be implemented manually. Further, although specific algorithms are described with reference to flowcharts depicted herein, persons of ordinary skill in the art will readily appreciate that many other methods of implementing the example machine readable instructions can alternatively be used. For example, the order of execution of the blocks can be changed, and/or some of the blocks described can be changed, eliminated, or combined.

It should be noted that the algorithms illustrated and discussed herein as having various modules or blocks or steps that perform particular functions and interact with one another are provided purely for the sake of illustration and explanation. It should be understood that these modules are merely segregated based on their function for the sake of description and represent computer hardware and/or executable software code which can be stored on a computer-readable medium for execution on appropriate computing hardware. The various functions of the different modules and units can be combined or segregated as hardware and/or software stored on a non-transitory computer-readable medium as above as modules in any manner, and can be used separately or in combination.

While many embodiments and modes for carrying out the present invention have been described in detail above, those familiar with the art to which this invention relates will recognize various alternative designs and embodiments for practicing the invention within the scope of the appended claims.

1. A gaming system for conducting a wagering game, the gaming system comprising:
a cabinet housing electronic components operable for conducting the wagering game;
one or more electronic input devices configured to receive a physical input from a player to initiate the wagering game and transform the physical input into an electronic data signal;
one or more electronic display devices operable to display aspects of the wagering game;
one or more electronic random element generators configured to generate one or more random elements associated with play of the wagering game;
one or more processors; and
one or more memory devices storing instructions that, when executed by at least one of the one or more processors, cause the one or more processors to:
initiate the wagering game in response to an electronic data signal from at least one of the one or more electronic input devices;
determine an outcome of the wagering game based, at least in part, on one or more random elements generated by at least one of the one or more random element generators;
direct at least one of the one or more electronic display devices to display a symbol array having a plurality of symbols located therein, the plurality of symbols being indicative of the randomly determined outcome of the wagering game, the symbols being selected from a plurality of available symbols including one or more standard game symbols, one or more collectable symbols, and one or more activator symbols;
for each collectable symbol displayed in the symbol array as part of the wagering game outcome, direct at least one of the one or more electronic display devices to display a respective transparent symbol superimposed in front of a corresponding array position of the collectable symbol;
direct at least one of the one or more electronic display devices to display in the symbol array a new plurality of symbols indicative of a new randomly determined outcome of the wagering game;
in response to an activator symbol displayed in the symbol array as part of the new wagering game outcome, direct at least one of the one or more electronic display devices to display each of the transparent symbols turning the corresponding array position into a respective special symbol;
evaluate the new game outcome for one or more winning symbol combinations; and
transmit an award to the player in response to the new game outcome including at least one of the one or more winning symbol combinations.

2. The gaming system of claim 1, wherein the displaying each of the transparent symbols turning the corresponding array positions into the special symbol is further in response to the activator symbol appearing within a predetermined activator-symbol area on the symbol array as part of the new randomly determined wagering game outcome.

3. The gaming system of claim 2, wherein the symbol array includes a plurality of columns, and wherein the predetermined activator-symbol area is a select one of the array columns.

4. The gaming system of claim 1, wherein each of the transparent symbols is continuously displayed superimposed in front of the symbol array for one or more subsequent plays of the wagering game until a deactivator symbol is displayed in the symbol array as part of the new wagering game outcome.

5. The gaming system of claim 1, wherein each of the transparent symbols is continuously displayed superimposed in front of the symbol array for one or more subsequent plays of the wagering game until the activator symbol is displayed in the symbol array as part of the new wagering game outcome.

6. The gaming system of claim 1, wherein the one or more memory devices store additional instructions that cause at least one of the one or more electronic display devices to display each of the transparent symbols disappearing substantially concurrent with or after the evaluating the new game outcome for winning symbol combinations.

7. The gaming system of claim 1, wherein the one or more memory devices store additional instructions that cause at least one of the one or more electronic display devices to display each of the transparent symbols superimposed in front the symbol array for one or more subsequent plays of the wagering game after the evaluating the new game outcome for winning symbol combinations.

8. The gaming system of claim 1, wherein the wagering game includes a plurality of symbol-bearing reels, and wherein the one or more memory devices store additional instructions that cause at least one of the one or more electronic display devices, prior to the displaying the new symbols indicative of the new wagering game outcome, to display the symbol-bearing reels spinning while each of the transparent symbols remains immobile superimposed in front of the symbol array.

9. The gaming system of claim 1, wherein the one or more memory devices store additional instructions that cause the gaming system to:
for each collectable symbol displayed in the symbol array as part of the new wagering game outcome, direct at least one of the one or more electronic display devices to display a respective transparent symbol superimposed in front of a corresponding array position of the collectable symbol;
direct at least one of the one or more electronic display devices to display in the symbol array another new plurality of symbols indicative of another new randomly determined outcome of the wagering game;
in response to an activator symbol displayed in the symbol array as part of the another new randomly determined game outcome, direct at least one of the one or more electronic display devices to display each of the transparent symbols turning the corresponding array position into a respective special symbol; and
evaluate the another new game outcome for one or more winning symbol combinations.

10. The gaming system of claim 1, wherein the displaying the wagering game outcome includes displaying a plurality of randomly determined wagering game outcomes, and wherein for each collectable symbol displayed in the symbol array as part the plurality of wagering game outcomes, continuously display a respective transparent symbol superimposed in front of a corresponding array position of the collectable symbol.

11. The gaming system of claim 1, wherein all of the special symbols provided by the transparent symbols in the symbol array are the same type of special symbol.

12. (canceled)

13. The gaming system of claim 1, wherein the displaying each of the transparent symbols turning the corresponding array position into the special symbol is further in response to the activator symbol appearing within a predetermined winning outcome on the symbol array as part of the new randomly determined wagering game outcome.

14. A gaming system for conducting a wagering game, the gaming system comprising:
a cabinet for housing electronic components operable for conducting the wagering game;
one or more electronic input devices coupled to the housing and configured to receive one or more physical inputs from a player and generate one or more electronic data signals indicative thereof;
one or more electronic display devices coupled to the housing and operable to display aspects of the wagering game;
one or more electronic random element generators configured to generate one or more random elements associated with play of the wagering game;
one or more processors; and
one or more memory devices storing instructions that, when executed by at least one of the one or more processors, cause the gaming system to:
in response to an indication of a wager received via at least one of the one or more electronic input devices, determine a first outcome of the wagering game based, at least in part, on one or more random elements generated by at least one of the one or more random element generators, the wagering game including a plurality of symbol-bearing reels, and the first wagering-game outcome being randomly selected from a plurality of available wagering-game outcomes;
direct at least one of the electronic display devices to display the reels populating a symbol array with symbols indicative of the randomly selected first outcome of the wagering game, the symbols being selected from a plurality of available symbols including one or more standard game symbols, one or more special game symbols, one or more collectable symbols, and one or more activator symbols;
for each collectable symbol displayed in the symbol array as part of the first wagering game outcome, if any, direct at least one of the electronic display devices to display a respective transparent symbol superimposed in front of a corresponding array position of the collectable symbol for one or more subsequent plays of the wagering game;
determine a second randomly selected outcome of the wagering game;
direct at least one of the electronic display devices to display the symbol-bearing reels spinning while each of the transparent symbols remains immobile superimposed in front of the symbol array;
direct at least one of the electronic display devices to display the reels populating the symbol array with symbols indicative of the second wagering-game outcome;
in response to an activator symbol displayed within a predetermined activator-symbol area in the symbol array as part of the second wagering-game outcome, if any, direct at least one of the electronic display devices to display each of the transparent symbols turning the corresponding array position into a respective special symbol;
evaluate the second wagering-game outcome for one or more winning symbol combinations; and
transmit an award to the player in response to the second wagering-game outcome including at least one of the one or more winning symbol combinations.

15. A method for conducting a wagering game on a gaming system, the gaming system including one or more electronic input devices, one or more electronic display devices, one or more electronic random element generators, and one or more processors, the method comprising:
receiving, via at least one of the one or more electronic input devices, an indication of a wager to play the wagering game;
initiating, via at least one of the one or more processors, the wagering game in response to the received wager;
determining, via at least one of the one or more processors, an outcome of the wagering game based, at least in part, on one or more random elements generated by at least one of the one or more random element generators, the outcome being randomly determined from a plurality of available wagering-game outcomes;
displaying, via at least one of the one or more display devices, a symbol array populated with a plurality of symbols indicative of the randomly determined wagering-game outcome, the symbols being selected from a plurality of available symbols including one or more standard game symbols, one or more collectable symbols, and one or more activator symbols;
displaying, via at least one of the one or more display devices for each collectable symbol displayed in the wagering game outcome, a respective transparent symbol superimposed in front of a corresponding array position of the collectable symbol;
displaying, via at least one of the one or more display devices, the symbol array populated with a new plurality of symbols indicative of a new randomly determined outcome of the wagering game;
displaying, via at least one of the one or more display devices in response to an activator symbol displayed in the new wagering-game outcome, each of the transparent symbols turning the corresponding array position into a respective special symbol;
evaluating, via at least one of the one or more processors, the new wagering-game outcome for one or more winning symbol combinations; and
transmitting an award in response to the new game outcome including at least one of the one or more winning symbol combinations.

16. The method of claim 15, wherein the displaying each of the transparent symbols turning the corresponding array positions into the special symbol is further in response to the activator symbol appearing within a predetermined activator-symbol area on the symbol array as part of the new randomly determined wagering game outcome.

17. The method of claim 15, wherein each of the transparent symbols is continuously displayed superimposed in front of the symbol array for one or more subsequent plays of the wagering game until a deactivator symbol is displayed in the symbol array as part of the new wagering game outcome.

18. The method of claim 15, wherein each of the transparent symbols is continuously displayed superimposed in front of the symbol array for one or more subsequent plays of the wagering game until the activator symbol is displayed in the symbol array as part of the new wagering game outcome.

19. The method of claim 15, further comprising displaying, via at least one of the one or more display devices, each of the transparent symbols disappearing concurrent with or after the evaluating the new game outcome for winning symbol combinations.

20. The method of claim 15, further comprising displaying, via at least one of the one or more display devices, each of the transparent symbols superimposed in front the symbol array for one or more subsequent plays of the wagering game after the evaluating the new game outcome for winning symbol combinations.

21. The method of claim 15, wherein the wagering game includes a plurality of symbol-bearing reels, the method further comprising displaying, via at least one of the one or more display devices prior to the displaying the new symbols indicative of the new wagering game outcome, the symbol-bearing reels spinning while each of the transparent symbols remains immobile superimposed in front of the symbol array.

22. (canceled)
